(19) United States
(12) Patent Application Publication
(10) Pub. No.: US 2011/0195229 A1
(43) Pub. Date: Aug. 11, 2011

(54) MOISTURE-PERMEABLE WATERPROOF FABRIC AND METHOD FOR MANUFACTURING THE SAME

(75) Inventors: Hajime Tone, Osaka (JP); Hideki Kawabata, Osaka (JP)

(73) Assignee: TOYOBO SPECIALTIES TRADING CO., LTD., Osaka (JP)

(21) Appl. No.: 13/123,409

(22) PCT Filed: Jun. 1, 2009
(86) PCT No.: PCT/JP2009/059949

§ 371 Date: Apr. 8, 2011

(51) Int. Cl. B32B 5/18; B32B 27/12; B32B 27/40; B05D 1/36

(52) U.S. Cl. 428/173; 427/412

(57) ABSTRACT

The invention provides a moisture-permeable waterproof fabric which not only has a tear strength at a practical level but also is light, thin, soft in texture and excellent in moisture permeability and waterproofness. The moisture-permeable waterproof fabric is a fabric in which two urethane resin layers are coated at least on one surface of a woven fabric, wherein a first urethane resin layer is a porous urethane resin layer which is discontinuously coated on the surface of the woven fabric to fill recesses of a weave crimp but not to cover at least a part of projections of the weave crimp; and a second urethane resin layer is a hydrophilic urethane resin layer which is continuously coated on the first urethane resin layer and the projections of the weave crimp.

### TECHNICAL FIELD

The present invention relates to a moisture-permeable waterproof fabric and a method for manufacturing the same. Specifically, the present invention relates to a fabric which not only has a tear strength at a practical level but also is light, thin, soft in texture and excellent in moisture permeability and waterproofness, as well as a method for manufacturing the same.

### BACKGROUND ART

As a waterproof fabric for raincoats, ski apparel and the like, a fabric having high moisture permeability, which can reduce humid feel during wearing, is often used. However, in recent years, a fabric having higher functionality such as high performance, lightness, compactness, comfort and the like, has been desired.

Conventionally, a porous resin layer and a nonporous resin layer are known in a moisture-permeable waterproof fabric in which a resin layer is formed on a surface of a woven fabric by a wet or dry coating method. For example, Patent Document 1 discloses a moisture-permeable waterproof coating fabric having a microporous layer made from a polyurethane resin. In the case where the resin layer is porous, excellent moisture permeability is easily obtained, but waterproofness tends to be insufficient. If the thickness of the porous resin layer is 20 μm or less, waterproofness greatly deteriorates, thus it is difficult to decrease the thickness further. On the other hand, in the case where the resin layer is nonporous, excellent waterproofness is easily obtained, but moisture permeability tends to be insufficient. If the thickness is decreased in order to increase moisture permeability, water bearing pressure and moisture permeability become unstable, so that it is difficult to obtain uniform performance.

In order to obtain more excellent moisture permeability and waterproofness, a method in which a microporous film layer is firstly formed on a fiber base material and then a nonporous film layer is formed on the microporous film layer, has been adopted (e.g., Patent Document 2). However, in this method, how thin the nonporous film layer is coated, the microporous film layer cannot be thinly coated, thus there are limitations on reduction in film thickness.

On the other hand, in order to obtain a moisture-permeable waterproof woven fabric with lightweight feel, a moisture permeable waterproof woven fabric in which a small amount of resin is laminated on one surface of a woven fabric having a cover factor (CF) of 1900 to 2500, a warp cover factor to weft cover factor ratio of 1.25 or more, and a warp projection rate of 6.0% or more, has been proposed (e.g., Patent Document 3). However, in order to increase the warp projection rate, a yarn having a high fineness and a large filament number has to be used to form a high density woven fabric. As a result, the woven fabric becomes heavy and hard, so that a really light and soft woven fabric has not been provided.

In addition, in order to obtain satisfactory thinness and lightness, it is necessary to use a woven fabric thinly woven using a thin yarn. However, by doing so, permeation of the resin to the back side is likely to occur when a resin layer is laminated; or the tear strength of the moisture-permeable waterproof fabric is insufficient for a practical level.

### PRIOR ART DOCUMENTS

### Patent Documents

Patent Document 1: Japanese Patent Publication No. H09-158051 A
Patent Document 2: Japanese Patent Publication No. S60-196336 A
Patent Document 3: Japanese Patent Publication No. 2008-144310 A

### DISCLOSURE OF INVENTION

### Problems to be Solved by the Invention

The present invention is made in consideration of the above problems, and the object thereof is to provide a fabric which not only has a tear strength at a practical level but also is light, thin, soft in texture and excellent in moisture permeability and waterproofness, as well as a method for manufacturing the same.

### Means for Solving Problem

The present inventors have finally completed the present invention, as a result of wholehearted investigation about the above problems. That is, the moisture-permeable waterproof fabric of the present invention is a moisture-permeable waterproof fabric in which two urethane resin layers are laminated at least on one surface of a woven fabric, wherein a first urethane resin layer is a porous urethane resin layer which is discontinuously laminated on the surface of the woven fabric to fill recesses of a weave crimp but not to cover at least a part of projections of the weave crimp, and a second urethane resin layer is a hydrophilic urethane resin layer which is continuously laminated on the first urethane resin layer and the projections of the weave crimp. As described above, unevenness of the woven fabric surface is eliminated by only filling recesses on the woven fabric surface with the first urethane resin layer, thus the second urethane resin layer can be laminated relatively uniformly to the same level as the one laminated on a smooth film. Therefore, the variation of moisture permeability and waterproofness of the fabric can be suppressed, and moisture permeability and waterproofness can be greatly increased even when the average film thickness is the same as that of a conventional product. This means that the thickness of hydrophilic urethane resin layer, which is used to obtain the same moisture permeability and waterproofness as that of a conventional product, can be greatly reduced. In addition, the above-described structure in which the porous first urethane resin layer having a void structure is laminated to fill the recesses of the woven fabric surface and the hydrophilic second urethane resin layer is relatively uniformly laminated thereon, less impairs the softness of the fabric and thus very soft texture of the fabric can be kept, when compared to a structure having the same thickness in which only an nonporous resin layer is laminated.

The thickness of the second urethane resin layer is preferably 1 to 30 μm, and the thickness variation of the second urethane resin layer is preferably 80% or less.

The woven fabric preferably uses a yarn having a total fineness of 8 to 25 dtex which is made from nylon 6 and/or nylon 66 having a relative viscosity of 3.0 or more, the cover factor (CF) of the woven fabric is preferably 1700 to 2200, and the weave of the woven fabric is preferably a plain weave, a ripstop or a double ripstop. As described above, by using the material having a high relative viscosity and specifying the range of the cover factor as well as the weave, not only permeation of the resin to the back side can be prevented even using a thin yarn having a total fineness of 22 dtex or less which could not be used in the past, but also a moisture-permeable waterproof fabric which is light, thin, soft and has a tear strength at a practical level as well can be obtained, by a synergistic effect with the softness originated from the above structure.

The thickness of the moisture-permeable waterproof fabric is preferably 0.1 mm or less, the tear strength of the moisture-permeable waterproof fabric in each of warp direction and weft direction, which is measured by JIS L 1096 8. 15. 5 D method, is preferably 8.0 N or more, and the bending resistance of the moisture-permeable waterproof fabric in each of warp direction and weft direction, which is measured by JIS L 1096 8. 19. 1 A method, is preferably 5 to 35 mm. More preferably, the tear strength of the moisture-permeable waterproof fabric in each warp direction and weft direction is 10.0 N or more. In addition, the moisture permeability of the moisture-permeable waterproof fabric, which is measured by JIS L 1099 A-1 method, is preferably 4000 mm/m²·24 hr or more, and the water bearing pressure of the moisture-permeable waterproof fabric, which is measured by JIS L 1092 B method, is preferably 50 kPa or more.

In addition, a method for manufacturing the above-described moisture-permeable waterproof fabric is also included in the present invention. The method comprises steps of (1) coating a first urethane resin liquid for a first urethane resin layer on a surface of a woven fabric to fill recesses of a weave crimp but not to cover at least a part of projections of the weave crimp, and then forming the first urethane resin layer by a wet solidification method; and (2) continuously coating a second urethane resin liquid for a second urethane resin layer on the first urethane resin layer and the projections of the weave crimp, and then forming the second urethane resin layer by a dry method.

### Effect of the Invention

The moisture-permeable waterproof fabric of the present invention not only has a tear strength at a practical level but also is light, thin, soft in texture and excellent in moisture permeability and waterproofness. The moisture-permeable waterproof fabric of the present invention is particularly useful for various clothing such as raincoats, outer garments and the like as well as outdoor goods. The product obtained from the moisture-permeable waterproof fabric of the present invention can be stored very compactly and is light, thus the product is very convenient to be carried outside. Further, when the moisture-permeable waterproof fabric is used for clothing, it is easy and comfortable for the movement of body when wearing the clothing, thus comfort can be provided and decrease in ability to exercise can be reduced.

### BRIEF DESCRIPTION OF THE DRAWINGS

FIG. 1 is an SEM cross-sectional photograph showing the porous urethane resin layer of the present invention.

FIG. 2 is an SEM cross-sectional photograph of an example of the moisture-permeable waterproof fabric of the present invention.

FIG. 3 is a schematic diagram of a double ripstop weave used for the woven fabric of the present invention.

FIG. 4 is a schematic diagram of a ripstop weave used for the woven fabric of the present invention.

### MODE FOR CARRYING OUT THE INVENTION

Hereinafter, an embodiment of the present invention will be described in detail. However, the present invention is not limited to the embodiment described below, and various modifications can be made thereto without departing from the scope of the present invention.

The moisture-permeable waterproof fabric of the present invention is a moisture-permeable waterproof fabric in which two urethane resin layers are laminated at least on one surface of a woven fabric, wherein a first urethane resin layer is a porous urethane resin layer which is discontinuously laminated on the surface of the woven fabric to fill recesses of a weave crimp but not to cover at least a part of projections of the weave crimp; and a second urethane resin layer is a hydrophilic urethane resin layer which is continuously laminated on the first urethane resin layer and the projections of the weave crimp.

Firstly, the woven fabric used in the moisture-permeable waterproof fabric of the present invention will be specifically described. For the moisture-permeable waterproof fabric of the present invention, a woven fabric, a knitted fabric or a nonwoven fabric which is made from a polyamide synthetic fiber typified by nylon 6 and nylon 66; a polyester synthetic fiber typified by polyethylene terephthalate; a polyacrylonitrile synthetic fiber; a polyvinyl alcohol synthetic fiber; a semi-synthetic fiber such as triacetate; or a blend fiber such as nylon 6/cotton or polyethylene terephthalate/cotton, can be used. However, in order to obtain a fabric which is light and thin and has high tear strength, a woven fabric using a yarn made from nylon 6 and/or nylon 66 is suitably used.

When nylon is used for the yarn, the relative viscosity thereof is preferably not less than 2.5, and more preferably not less than 3.0, and is preferably not more than 4.0, and more preferably not more than 3.8. When the relative viscosity is not less than 2.5, the tear strength of the obtained fabric reaches a practical level. When the relative viscosity is not less than 3.0, the tear strength of the fabric becomes not less than 8.0 N and thus sufficient strength can be obtained. On the other hand, when the relative viscosity is less than 2.5, the problems such as decrease in tear strength of the product due to insufficient breaking strength; deterioration of processing operability due to insufficient breaking elongation; and deterioration of product durability, are likely to arise. In addition, when the relative viscosity exceeds 4.0, a product with high toughness is obtained, however, not only polymerization facility and spinning equipment corresponding to the high viscosity are needed, but also productivity remarkably decreases due to the high viscosity and raw yarn cost increases, therefore, a cheap and highly functional product cannot be provided for consumers.

The single fiber fineness of the yarn is not particularly limited, but is preferably not less than 0.4 dtex, and more preferably not less than 0.6 dtex, and is preferably not more than 2.0 dtex, and more preferably not more than 1.5 dtex. By setting the single fiber fineness in the above range, a fabric having a good balance between texture and tear strength can be obtained. On the other hand, when the single fiber fineness is less than 0.4 dtex, the fiber is so thin that it is difficult to produce a yarn having sufficient strength and quality by the present production technology. In addition, when the single fiber fineness exceeds 2.0 dtex, the texture is hard, or it is difficult to produce a light and thin fabric.

The total fineness of the yarn is preferably not less than 5 dtex, more preferably not less than 8 dtex, and is preferably not more than 33 dtex, and more preferably not more than 25 dtex. By setting the total fineness in the above range, a fabric which is light and thin and has practical tear strength can be obtained. On the other hand, when the total fineness is less than 5 dtex, it is difficult to obtain necessary strength, and when the total fineness is more than 33 dtex, the obtained fabric becomes bulky and thus it is difficult to produce a light and thin fabric.

The breaking strength of the yarn is not particularly limited, but is preferably not less than 4.0 cN/dtex, more preferably not less than 4.5 cN/dtex, and even more preferably not less than 5.0 cN/dtex. When the breaking strength of the yarn is not less than 4.0 cN/dtex, a fabric having sufficient tear strength can be obtained.

The cover factor (CF) of the woven fabric is preferably not less than 1700, more preferably not less than 1800, and even more preferably not less than 1900. In addition, the cover factor is preferably not more than 2200, more preferably not more than 2100, and even more preferably not more than 2000. By setting the cover factor of the woven fabric in the above range, a light, thin and soft fabric without permeation of the coating resin to the back side can be obtained. On the other hand, when the cover factor is less than 1700, the obtained fabric is light and thin, but permeation of the coating resin to the back side is likely to occur. In addition, when the cover factor exceeds 2200, the tear strength of the obtained fabric is likely to decrease, or the texture is likely to become hard. Here, the cover factor (CF) of the woven fabric is calculated according to the following equation.

CF=T×(DT)^{1/2}+W×(DW)^{1/2}

In the equation, T and W indicate warp density and weft density (yarn/inch) of the woven fabric, respectively, and DT and DW indicate fineness (dtex) of warp and weft constituting the woven fabric, respectively.

Further, the weave of the woven fabric is not particularly limited and an optional weave such as a plain weave, a twill weave or a sateen weave can be used, but a plain weave is preferably used for the purpose of obtaining a light and thin fabric. In addition, in order to increase the tear strength of the fabric, a ripstop is more preferably used, and a double ripstop is even more preferably used.

The urethane resin layers which are laminated on the moisture-permeable waterproof fabric of the present invention will be specifically describe below.

The urethane resin used for forming the first and second urethane resin layers which are laminated on the moisture-permeable waterproof fabric of the present invention, is the one containing a urethane resin component in an amount of 50 to 100% by mass and the other synthetic polymer component in an amount of less than 50% by mass.

The urethane resin is a copolymer obtained by reacting polyisocyanate and polyol. As polyisocyanate, aromatic diisocyanate, aliphatic diisocyanate or alicyclic diisocyanate can be used solely or as a mixture thereof, and examples thereof include 2,4-tolylene diisocyanate, 4,4′-diphenylmethane diisocyanate, 1,6-hexane diisocyanate and 1,4-cyclohexane diisocyanate. In addition, as polyol, polyether polyol or polyester polyol can be used. Examples of polyether polyol include polyethylene glycol, polypropylene glycol, and polytetramethylene glycol. Examples of polyester polyol include reaction product of diol such as ethylene glycol and propylene glycol with dibasic acid such as adipic acid and sebacic acid, and ring-opening polymerization product of caprolactone.

Examples of the other synthetic polymer component include poly(meth)acrylic acid, polyvinyl chloride, polystyrene, polybutadiene, polyamino acid, and copolymer thereof.

Further, for the purpose of improving moisture permeability and moisture absorption or preventing dew condensation, inorganic or organic fine particle may be added to the urethane resin. Examples of the inorganic fine particle suitably used include fine particle of silicon compound such as silicon dioxide, silicon carbide and silicon nitride; fine particle of magnesium compound such as magnesium oxide, magnesium hydroxide and magnesium sulfate; and particle surface modified product thereof. Examples of the organic fine particle include fine particles of cellulose, collagen, animal protein, polysaccharide and poly(meth)acrylate.

The size of the fine particle is not particularly limited, but the average particle diameter thereof is preferably not more than 10.0 μm, more preferably not more than 3.0 μm, and even more preferably not more than 1.0 μm, for the purpose of improving moisture permeability. When the particle diameter is more than 10.0 μm, the diameter of pore formed in the urethane resin layer of the obtained fabric is large and thus waterproofness is likely to deteriorate. The addition amount of the fine particle is also not limited and an amount required to achieve the purpose may be added appropriately.

Moreover, in the present invention, for the purpose of improving peeling resistance between the urethane resin layer and the woven fabric, a compound having high affinity with the urethane resin or the woven fabric, for example, an isocyanate compound, may be used in combination with the urethane resin. As the isocyanate compound, 2,4-tolylene diisocyanate, diphenylmethane diisocyanate, isophorone diisocyanate, hexamethylene diisocyanate, or triisocyanate obtained by addition reaction of these diisocyanates and compounds containing active hydrogen (e.g., trimethylol propane and glycerin), can be used. In addition, the above isocyanates may be those in which the isocyanate group is free, or those in which phenol, methylethyl ketoxime or the like is added for stabilization and block is dissociated by later heat treatment, they may be appropriately used according to workability, use and the like. When the isocyanate compound is used, the addition amount thereof is desirably 0.1 to 10% by mass with respect to the urethane resin. When the used amount is less than 0.1% by mass, the adhesive force of the resin layer to the woven fabric may decrease and when the used amount exceeds 10% by mass, the texture tends to be hard.

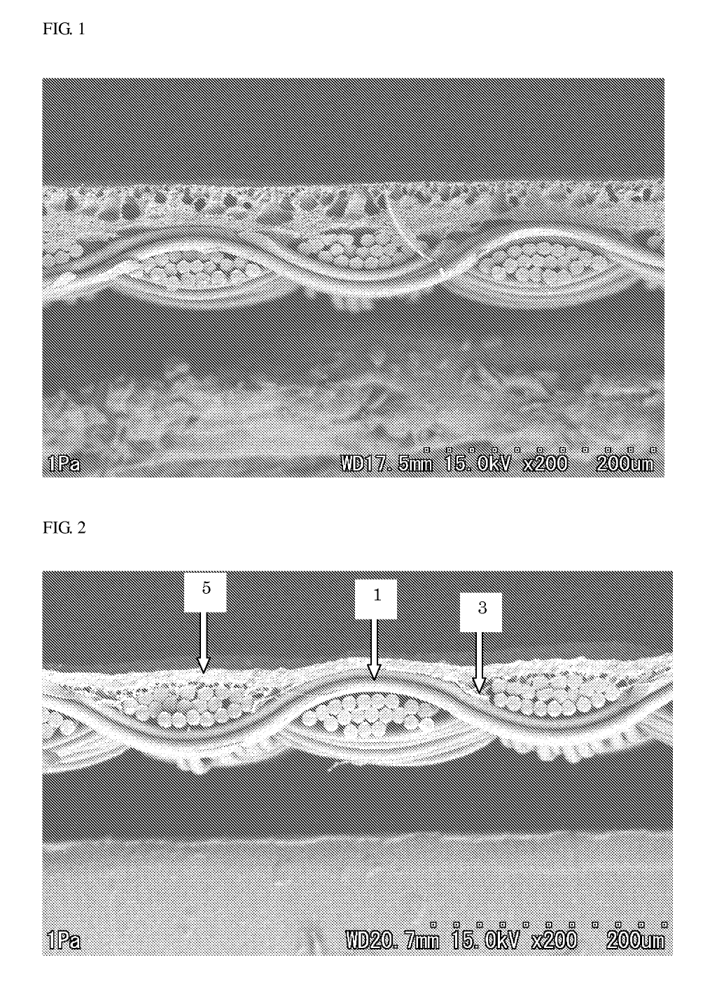

The first urethane resin layer is a porous urethane resin layer which is discontinuously laminated on the surface of the woven fabric to fill recesses of the weave crimp but not to cover at least a part of projections of the weave crimp. The porous urethane resin layer of the present invention is the one having a large number of micropores on the layer surface and relatively large voids communicating with these micropores inside the layer, and one example thereof is shown in FIG. 1. FIG. 1 is an SEM cross-sectional photograph of the one in which only the porous urethane resin layer is laminated on the surface of the woven fabric, for illustrating the porous urethane resin layer of the present invention. Such a porous urethane resin layer can be formed by the wet solidification method described hereinafter. As described above, by only filling recesses on the woven fabric surface with the first urethane resin layer, the hydrophilic second urethane resin layer can be laminated relatively uniformly to the same level as the one laminated on a smooth film. Therefore, the variation of moisture permeability and waterproofness of the fabric can be suppressed, and moisture permeability and waterproofness can be greatly increased even when the average film thickness is the same as that of a conventional product. This means that the thickness of hydrophilic urethane resin layer, which is used to obtain the same moisture permeability and waterproofness as that of a conventional product, can be greatly reduced. In addition, when the recesses on the woven fabric surface are filled with the porous first urethane resin layer having the void structure as descried above, the obtained moisture-permeable waterproof fabric can keep very soft texture, when compared to the fabric having the same thickness in which only the nonporous resin layer is laminated.

The thickness of the first urethane resin layer is about 0 μm at the top of the projection of the weave crimp, and changes depending on the depth of the recess at the recess of the weave crimp, but the thickness is preferably not less than 1 μm, more preferably not less than 3 μm, and even more preferably not less than 5 μm. In addition, the thickness is preferably not more than 20 μm, more preferably not more than 15 μm, and even more preferably not more than 10 μm. By setting the thickness of the first urethane resin layer in the above range, a fabric which is light, thin and soft in texture and has moisture permeability and waterproofness, can be obtained. On the other hand, when the thickness is less than 1 μm, the filling effect decreases, and when the thickness exceeds 20 μm, it is difficult to obtain a thin and soft fabric.

The attached amount of resin for obtaining the above thickness depends on the undulating shape and the smoothness of the coating surface of the woven fabric, but it is preferably not less than 0.5 g/m², more preferably not less than 1 g/m², and even more preferably not less than 2 g/m², in an amount after drying. In addition, the attached amount is preferably not more than 50 g/m², more preferably not more than 20 g/m², and even more preferably not more than 10 g/m². By setting the attached amount in the above range, a fabric which is light, thin and soft in texture and has moisture permeability and waterproofness, can be obtained. On the other hand, when the attached amount is less than 0.5 g/m², the filling effect decreases, and when the attached amount is more than 50 g/m², the projections of the weave crimp are also covered and thus it is difficult to obtain the intended thinness, lightness and soft texture.

The second urethane resin layer is a hydrophilic urethane resin layer which is continuously laminated on the first urethane resin layer and the projections of the weave crimp. The hydrophilic urethane resin layer of the present invention is formed mainly by a dry method using volatile organic solvent and/or water and thus does not have voids caused by elution of solvent. Because the resin itself has hydrophilicity, the hydrophilic urethane resin can absorb water and allow moisture to pass therethrough. As described above, since the first urethane resin layer is laminated to fill the recesses of the weave crimp but not to cover at least a part of the projections of the weave crimp, the unevenness of the woven fabric surface is eliminated. Therefore, the second urethane resin layer can be laminated relatively uniformly to the same level as the one laminated on a smooth film. As a result, the variation of moisture permeability and waterproofness of the obtained moisture-permeable waterproof fabric can be suppressed, and moisture permeability and waterproofness can be greatly increased even when the average film thickness is the same as that of a conventional product.

The thickness of the second urethane resin layer is preferably not less than 1 μm, more preferably not less than 3 μm, and even more preferably not less than 5 μm. In addition, the thickness is preferably not more than 30 μm, more preferably not more than 25 μm, and even more preferably not more than 20 μm. By setting the thickness of the second urethane resin layer in the above range, a fabric which achieves both desired thinness and lightness; and desired moisture permeability and waterproofness, can be obtained. On the other hand, when the thickness is less than 1 μm, sufficient water bearing pressure may not be obtained. In addition, when the thickness is more than 30 μm, the water bearing pressure improves, but the moisture permeability may decrease.

The attached amount of resin for obtaining the above thickness depends on the intended moisture permeability, water bearing pressure and the like, but it is preferably not less than 1 g/m², more preferably not less than 2 g/m², and even more preferably not less than 3 g/m². In addition, the attached amount is preferably not more than 50 g/m², more preferably not more than 40 g/m², and even more preferably not more than 30 g/m². By setting the attached amount in the above range, a fabric which achieves both desired thinness and lightness; and desired moisture permeability and waterproofness, can be obtained. On the other hand, when the attached amount is less than 1 g/m², sufficient water bearing pressure may not be obtained. In addition; when the attached amount is more than 50 g/m², the water bearing pressure improves, but the moisture permeability may decrease.

The thickness uniformity of the second urethane resin layer is important for stably obtaining desired moisture permeability and waterproofness. The thickness variation is preferably not more than 80%, more preferably not more than 50%, and even more preferably not more than 30%. When the thickness variation is more than 80%, it is difficult to stably obtain desired moisture permeability and waterproofness. The method of calculating the thickness variation will be described later.

Further, the first urethane resin layer and the second urethane resin layer may be laminated on one surface of the woven fabric, or may be laminated on both surfaces of the woven fabric.

As described above, in the present invention, a thin and light moisture-permeable waterproof fabric which has been never obtained in the past, can be produced by improving the moisture-permeable waterproof layer. Further, by specifying the structure of the woven fabric which is the base material, a moisture-permeable waterproof fabric in which not only the strength thereof is kept at a practical level but also the thinness thereof reaches to an ultimate level without permeation of the coating resin to the back side, can be obtained.

The moisture-permeable waterproof fabric of the present invention will be specifically describe below.

The moisture-permeable waterproof fabric of the present invention is the one in which the first urethane resin layer and the second urethane resin layer are laminated at least on one surface of the woven fabric. FIG. 2 is an SEM cross-sectional photograph of an example of the moisture-permeable waterproof fabric of the present invention. In FIG. 2, the first urethane resin layer 3 is discontinuously laminated on the surface of the woven fabric 1 to fill the recesses of the weave crimp but not to cover at least a part of the projections of the weave crimp, and the second urethane resin layer 5 is continuously laminated on the first urethane resin layer 3 and the projections of the weave crimp.

The total thickness of the moisture-permeable waterproof fabric of the present invention is preferably not more than 0.1 mm, and more preferably not more than 0.08 mm. When the thickness is not more than 0.1 mm, the obtained fabric is light and thin and can be stored compactly.

The tear strength of the moisture-permeable waterproof fabric in each of warp direction and weft direction is preferably in the range of 7.0 to 20.0 N, more preferably in the range of 8.0 to 20.0 N, and even more preferably in the range of 10.0 to 20.0 N. By setting the tear strength in the above range, a fabric having practical strength can be obtained. On the other hand, when the tear strength is less than 7.0 N, damage such as break is likely to occur during use. In addition, when the tear strength exceeds 20.0 N, it is necessary to use a very strong yarn in strength which is not used widely for clothing, and there are also many drawbacks in aspects of texture and dyeing. Here, the tear strength is measured by JIS L 1096 8. 15. 5 D method.

The bending resistance of the moisture-permeable waterproof fabric in each of warp direction and weft direction is preferably not less than 5 mm, and more preferably not less than 10 mm, and is preferably not more than 35 mm, more preferably not more than 30 mm, and even more preferably not more than 25 mm. By setting the bending resistance in the above range, a fabric which has required strength and water bearing pressure and is light, thin and soft, can be obtained. On the other hand, when the bending resistance is less than 5 mm, it is necessary to decrease the density of the woven fabric or further to decrease the thickness of the urethane resin layer, so that it is difficult to obtain required strength and water bearing pressure. In addition, when the bending resistance exceeds 35 mm, it is difficult to obtain a light, thin and soft fabric which is intended by the present invention. Here, the bending resistance is measured by JIS L 1096 8. 19. 1 A method.

The moisture permeability of the moisture-permeable waterproof fabric is preferably not less than 4000 mm/m²·24 hr, and more preferably not less than 5000 mm/m²·24 hr. When the moisture permeability is not less than 4000 mm/m²·24 hr, a fabric having practical moisture permeability can be obtained. Here, the moisture permeability is measured by JIS L 1099 A-1 method.

The water bearing pressure of the moisture-permeable waterproof fabric is preferably not less than 35 kPa, and more preferably not less than 50 kPa. When the water bearing pressure is not less than 35 kPa, a fabric having water bearing pressure satisfying a practical level can be obtained. Here, the water bearing pressure is measured by JIS L 1092 B method.

The method for manufacturing the moisture-permeable waterproof fabric of the present invention will be specifically described below.

The method for manufacturing the moisture-permeable waterproof fabric of the present invention comprises steps of (1) coating a first urethane resin liquid for a first urethane resin layer on a surface of a woven fabric to fill recesses of a weave crimp but not to cover at least a part of projections of the weave crimp, and then forming the first urethane resin layer by a wet solidification method; and (2) continuously coating a second urethane resin liquid for a second urethane resin layer on the first urethane resin layer and the projections of the weave crimp, and then forming the second urethane resin layer by a dry method.

The step (1) is a step for forming the porous first urethane resin layer which is discontinuously laminated on the surface of the woven fabric to fill the recesses of the weave crimp but not to cover at least a part of the projections of the weave crimp

As the first urethane resin liquid, a solution which is formed by dissolving the urethane resin in a polar organic solvent, can be used. Examples of the polar organic solvent used include N,N-dimethylformamide, dimethylacetamide, dimethyl sulfoxide, N-methylpyrrolidone and hexamethylene phosphonamide.

The first urethane resin liquid is discontinuously coated to fill the recesses of the weave crimp but not to cover at least a part of the projections of the weave crimp. According to the object of the present invention, the first urethane resin liquid is ideally applied only to the recesses of the weave crimp, but it is industrially difficult. Therefore, it is acceptable if the first urethane resin liquid is attached to a part of the surface of the projections of the weave crimp. As the coating method, a conventional coating method utilizing, for example, a knife coater, a comma coater, a reverse coater or a gravure coater may be used to conduct appropriate coating. In order to obtain the film thickness and the attached amount such that only the recesses of the weave crimp are filled without impairing the texture, the knife coater by which a thin coating can be made, is suitably used. For example, by rubbing the knife against the woven fabric without providing clearance between the knife of the coater and the woven fabric, the first urethane resin liquid can be discontinuously coated to fill the recesses of the weave crimp.

After the coating of the resin liquid, the porous urethane resin layer is formed by the wet solidification method. As the wet solidification method, a conventional wet urethane coating method may be used. For example, after the resin liquid is coated on the woven fabric, the woven fabric is immersed in water at 0 to 30° C. for 0.5 to 10 minutes to perform wet solidification of the resin component, then washed in water at 40 to 60° C. for 5 to 15 minutes, and dried by a conventional method.

The step (2) is a step for forming the hydrophilic second urethane resin layer which is continuously laminated on the first urethane resin layer and the projections of the weave crimp.

As the second urethane resin liquid, an emulsion which is obtained by mixing and uniformly emulsifying the urethane resin with a volatile solvent and/or water, can be used. Examples of the volatile solvent used include ketone solvents and aromatic hydrocarbon solvents, and typical examples thereof include acetone, methyl ethyl ketone, methyl isobutyl ketone, toluene and xylene.

The second urethane resin liquid is continuously and relatively uniformly coated on the first urethane resin layer and the projections of the weave crimp. As the coating method, a conventional coating method utilizing, for example, a knife coater, a comma coater, a reverse coater or a gravure coater may be used to conduct appropriate coating. However, the knife coater by which a thin coating can be made, is suitably used.

After the coating of the resin liquid, the hydrophilic second urethane resin layer is formed by a dry method. As the dry method, a conventional dry urethane coating method may be used. In a typical method, after the coating of the resin liquid, the volatile solvent and/or water are transpired by drying treatment to form the layer.

In the present invention, in order to prevent the urethane resin from permeating inside the woven fabric, water-repellent treatment is suitably conducted before the urethane resin layer is formed on the woven fabric. As a water-repellent agent, a known water-repellent agent such as a paraffin water-repellent agent, a polysiloxane water-repellent agent or a fluorine water-repellent agent, may be used, and the treatment may be conducted by a known method such as a padding method or a spray method. When particularly excellent water repellency is required, the fluorine water-repellent agent is preferably used. For example, padding (pickup: 35%) can be conducted with a water dispersion of about 5% by mass of Asahi Guard LS317 (fluorine water-repellent agent emulsion, manufactured by Asahi Glass Co., Ltd.), and then heat treatment at 160° C. is conducted for 1 minute.

In order to improve moisture permeability and waterproofness, calender process may be conducted as another pretreatment. However, since calender process is likely to impair the softness of the fabric, it is not preferred to conduct calender process in the present invention. When calender process is conducted, the cylinder temperature is preferably 100° C. to 180° C., more preferably 120° C. to 170° C., and even more preferably 140° C. to 150° C. When the cylinder temperature is lower than 100° C., it is difficult to obtain a sufficient pressing effect, and when the cylinder temperature exceeds 180° C., the softness of the fabric is lost due to the strong pressing effect and intended soft texture is likely to be impaired.

Further, in the present invention, for the purpose of further improving the waterproofness, water-repellent treatment is suitably conducted after the moisture-permeable waterproof layer is formed. Similarly to the above pretreatment, as the water-repellent agent, the known water-repellent agent such as the paraffin water-repellent agent, the polysiloxane water-repellent agent or the fluorine water-repellent agent, may be used, and the water repellent treatment may be conducted by the padding method, the spray method or the coating method.

Moreover, in the present invention, for the purpose of providing a design, hiding processing drawback such as coating lines, improving slip feel to improve tackiness and wearing feel, or improving abrasion resistance of the urethane resin layer, it is also preferred to laminate a pattern layer on the moisture-permeable waterproof layer. This pattern layer mainly consists of a synthetic resin, and is formed uniformly but not to the entire surface by means of gravure coating, rotary printing, flat screen printing or the like. As the synthetic resin, polyurethane resin, polyester resin, polyamide resin, acrylic resin, silicone resin, vinyl chloride resin, polyolefin resin, ethylene-vinyl acetate resin or the like can be used. These resins may be used solely or as a mixture thereof. In addition, when slip feel would like to be provided to the pattern layer, a slip additive is preferably contained. The slip additive is not particularly limited, and examples of an organic slip additive include silicone compound such as polydimethylsiloxane; plate-like powder of N-lauroyl-L-lysine which is the reaction product of L-lysine and an organic acid; various heat-resistant organic filler fine powder; and the like. Examples of an inorganic slip additive include microporous amorphous silica (silicon dioxide) fine powder obtained by a wet method (a sedimentation method, a gel method); various inorganic filler fine powder; and the like. Further, according to need, a decorative agent such as a dye, a pigment, a filler, a pearl pigment or the like, or a functional agent such as a heat reserving agent, an antibacterial agent, a deodorizer or the like, may be contained in the pattern layer.

### Example

The present invention will be described in detail below, with reference to Examples and Comparative Examples, but the present invention is not limited to them. Modifications which are made to practice the present invention without departing from the gist described above and below, are included in the technological scope of the present invention. In addition, measurement and evaluation of characteristic values in Examples and Comparative Examples of the present invention were performed by following methods.

<Relative Viscosity of Polymer>

A sample solution was prepared by dissolving a polymer sample in special grade concentrated sulfuric acid of 96.3±0.1% by mass such that the concentration of the polymer was 10 mg/ml. An Ostwald viscometer in which the fall time of water is 6 to 7 seconds at a temperature of 20° C.±0.05° C. was used, and the fall time T₁ (second) of 20 ml of the prepared sample solution and the fall time T₀ (second) of 20 ml of the special grade concentrated sulfuric acid of 96.3±0.1% by mass which was used for dissolving the sample, were measured at a temperature of 20° C.±0.05° C., respectively. The relative viscosity (RV) of the polymer was calculated according to the following equation.

RV=T₁/T₀

<Fineness of Yarn>

The total fineness (dtex) was obtained by preparing three hanks of 100 m yarn, accurately weighing each hank (g), calculating the average value of them, and multiplying the average value by 100.

<Strength of Yarn>

A 4301 model universal material tester manufactured by Instron Japan Co., Ltd. was used, a load equivalent to 1/33 g of the yarn fineness was applied to the sample having a length of 20 cm at a pulling rate of 20 cm/min, and three measurements were conducted. The average value of strengths at break was regarded as the breaking strength.

<Elongation of Yarn>

The measuring method was similar to that for the above breaking strength. The average value of elongations at break was regarded as the elongation.

<Cover Factor of Woven Fabric>

The cover factor (CF) of woven fabric was calculated according to the following equation.

CF=T×(DT)^{1/2}+W×(DW)^{1/2}

In the equation, T and W indicate warp density and weft density (yarn/inch) of the woven fabric, respectively, and DT and DW indicate fineness (dtex) of warp and weft constituting the woven fabric, respectively.

<Thickness of Hydrophilic Urethane Resin Layer>

The cross section in the weft direction of the moisture-permeable waterproof fabric was cut out with a sharp safety razor by moving the blade between warps along the warps with the help of a ruler. Then, the cross-sectional photograph was taken with an SEM at a magnification of 500 times. Three photographs of different locations were optionally taken. The thickness of the hydrophilic urethane resin layer in each photograph was measured with a ruler, and the actual thickness was calculated according to the unit scale appended to the photograph. The maximum value and the minimum value were measured for each photograph, and the average value (n=3) of the median values thereof was regarded as the thickness. In Comparative Example 3, the thickness of the porous urethane resin layer was similarly measured.

<Thickness Variation of Hydrophilic Urethane Resin Layer>

When the average value of the median values is indicated by a, and the difference between the average value of the maximum values and the average value of the median values is indicated by b, the variation c was calculated according to the following equation.

c=100×b/a

<Thickness of Moisture-Permeable Waterproof Fabric>

The measurement was conducted according to JIS L 1096 Thickness of Woven Fabric. In the measurement, the pressure was 23.5 kPa, and the thickness was measured after the pressure was applied for 10 seconds.

<Tear Strength of Moisture-Permeable Waterproof Fabric>

The measurement was conducted according to JIS L 1096 8. 15. 5 D method (pendulum method). For each of the warp direction and the weft direction, the average value of n=5 was regarded as the tear strength.

<Bending Resistance of Moisture-Permeable Waterproof Fabric>

The measurement was conducted according to JIS L 1096 8. 19. 1 A method (45° cantilever method). For each of the warp direction and the weft direction, the average value of n=5 was regarded as the bending resistance.

<Moisture Permeability of Moisture-Permeable Waterproof Fabric>

The measurement was conducted according to JIS L 1099 A-1 method (calcium chloride method). The measurement was conducted at a temperature of 40° C. and a humidity of 90% RH, and the average value of n=3 was regarded as the moisture permeability.

<Water Bearing Pressure of Moisture-Permeable Waterproof Fabric>

The water bearing pressure was measured according to JIS L 1092 B method (high water pressure method).

<Texture of Moisture-Permeable Waterproof Fabric>

A plain woven fabric (130 warps and 116 wefts/inch) formed by using a 56T24F yarn of nylon 6 was dyed and set, the resultant fabric was used as a blank. Five evaluators were randomly selected, and a 5-degree evaluation was performed, for example, the one felt to be soft was given 5 points and the one felt to be hard was given 1 point.

### Example 1

A nylon 6 polymer chip having a relative viscosity of 3.5 was melt-spun at a spinning temperature of 288° C. In three godet rollers, the speed of the first roller was set at 2000 m/min, the speed of the second roller was set at 3500 m/min, the speed of the third roller was set at 3500 m/min, and stretching was conducted at a stretching temperature of 153° C. at the second roller. A yarn was obtained, which had a circular cross-section with a total fineness of 22 dtex, 20 filaments, a breaking strength of 5.5 cN/dtex and an elongation of 48%.

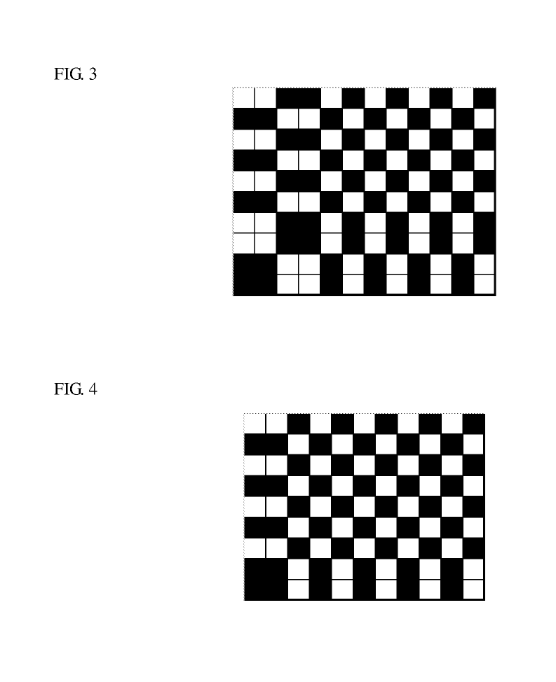

The yarn was used as warp and weft, the warp density was set as 186 yarns/inch and the weft density was set as 207 yarns/inch, and weaving was conducted using a water jet loom with a double ripstop weave as shown in FIG. 3. Scouring and dyeing (acid dye, DiacidFast Red 3B: 2% owf, manufactured by Mitsubishi Chemical Corporation) were conducted by conventional methods. Then, padding (pick up: 35%) was conducted with a water dispersion of 5% by mass of Asahi Guard LS317 (fluorine water-repellent agent emulsion, manufactured by Asahi Glass Co., Ltd.). After drying, heat treatment was conducted at 160° C. for 1 minute to obtain a woven fabric for coating. The obtained woven fabric had a warp density of 198 yarns/inch and a weft density of 221 yarns/inch.

Subsequently, a resin liquid shown in Formulation 1 for forming the first urethane resin layer was coated using a knife over roll coater, by rubbing the knife against the woven fabric without providing clearance between the knife and the woven fabric so that the recesses of the weave crimp were filled with the resin liquid but the resin liquid on the projection surface of the weave crimp was scraped off. As a result, the resin liquid had not been coated on the projection surface of the weave crimp. The woven fabric was immediately immersed in a water tank of 15° C. for 1 minute to solidify the resin, then immersed in a hot water tank of 50° C. for 10 minutes for washing, and dried using a hot air dryer. Next, a resin liquid having a resin solid content of 19% by mass shown in Formulation 2 for forming the second urethane resin layer was coated using a knife over roll coater, a film thickness after drying of 20 μM was obtained by adjusting the coating amount. Then, drying was conducted at 80° C. for 2 minutes, and heat treatment was conducted at 150° C. for 1 minute. The obtained moisture-permeable waterproof fabric was evaluated by the above evaluation methods. The results are shown in Table 1.

Formulation 1
RESAMINE CU-4555 (dimethylformamide solution containing 30% by mass of polyester polyurethane resin, manufactured by Dainichiseika Color & Chemicals Mfg. Co., Ltd.): 100 parts by mass
RESAMINE X crosslinking agent (isocyanate crosslinking agent, manufactured by Dainichiseika Color & Chemicals Mfg. Co., Ltd.): 2 parts by mass
Nipsil E200 (water-contained hydrophilic silicon dioxide fine powder, average particle diameter: 2.5 μm, manufactured by Nihon Silica Kogyo Co., Ltd.): 1 part by mass dimethylformamide: 30 parts by mass

Formulation 2
HI-MUREN Y-237NS (polyurethane resin: 25% by mass of nonvolatile content, manufactured by Dainichiseika Color & Chemicals Mfg. Co., Ltd.): 100 parts by mass
RESAMINE X-100 (isocyanate compound, manufactured by Dainichiseika Color & Chemicals Mfg. Co., Ltd.): 2 parts by mass
methyl ethyl ketone: 15 parts by mass
toluene: 15 parts by mass
water: 40 parts by mass

### Example 2

A moisture-permeable waterproof fabric was produced in a similar manner as Example 1, except that the weft density was changed to 220 yarns/inch and the woven fabric weave was changed to a ripstop weave as shown in FIG. 4. The obtained moisture-permeable waterproof fabric was evaluated in a similar manner as Example 1. The results are shown in Table 1.

### Example 3

A moisture-permeable waterproof fabric was produced in a similar manner as Example 1, except that the warp density and the weft density were changed to 180 yarns/inch and 212 yarns/inch, respectively, and the woven fabric weave was changed to a plain weave. The obtained moisture-permeable waterproof fabric was evaluated in a similar manner as Example 1. The results are shown in Table 1.

### Example 4

A moisture-permeable waterproof fabric was produced in a similar manner as Example 1, except that the coating amount of the resin liquid shown in Formulation 2 for forming the second urethane resin layer was adjusted so that the film thickness after drying of 5 μm was obtained, and the weave was changed to a ripstop weave. The obtained moisture-permeable waterproof fabric was evaluated in a similar manner as Example 1. The results are shown in Table 1.

### Example 5

A yarn was produced in a similar manner as Example 1, except that a nylon 6 polymer chip having a relative viscosity of 2.5 was used and the weave was changed to a ripstop weave. The obtained yarn had a circular cross-section with a total fineness of 22 dtex, 20 filaments, a strength of 4.1 cN/dtex and an elongation of 38%.

A moisture-permeable waterproof fabric was produced in a similar manner as Example 1 using the yarn for warp and weft. The obtained moisture-permeable waterproof fabric was evaluated in a similar manner as Example 1. The results are shown in Table 1.

### Comparative Example 1

A moisture-permeable waterproof fabric was produced in a similar manner as Example 1, except that the warp density and the weft density of the woven fabric were changed to 240 yarns/inch and 220 yarns/inch, respectively, and the weave was changed to a ripstop weave. The obtained moisture-permeable waterproof fabric was evaluated in a similar manner as Example 1. The results are shown in Table 2.

### Comparative Example 2

A moisture-permeable waterproof fabric was produced in a similar manner as Example 1, except that the warp density and the weft density of the woven fabric were changed to 181 yarns/inch and 134 yarns/inch, respectively, and the weave was changed to a ripstop weave. The obtained moisture-permeable waterproof fabric was evaluated in a similar manner as Example 1. The results are shown in Table 2.

### Comparative Example 3

A moisture-permeable waterproof fabric was produced in a similar manner as Example 1, except that the coating amount of the resin liquid shown in Formulation 1 for forming the first urethane resin layer was adjusted by using a conventional coating method so that the average film thickness after drying of 25 μm was obtained, the resin liquid of Formulation 2 was not coated, and the weave was changed to a ripstop weave. The obtained moisture-permeable waterproof fabric was evaluated in a similar manner as Example 1. The results are shown in Table 2.

### Comparative Example 4

A moisture-permeable waterproof fabric was produced in a similar manner as Example 1, except that the resin liquid for forming the first urethane resin layer was not coated and the weave was changed to a ripstop weave. The obtained moisture-permeable waterproof fabric was evaluated in a similar manner as Example 1. The results are shown in Table 2.

### Comparative Example 5

A moisture-permeable waterproof fabric was produced in a similar manner as Example 1, except that the coating amount of the resin liquid shown in Formulation 1 for forming the first urethane resin layer was adjusted by adjusting the clearance between the knife and the woven fabric so that the average film thickness after drying of about 10 μm was obtained, the coating amount of the resin liquid shown in Formulation 2 for forming the second urethane resin layer was adjusted so that the average film thickness after drying of about 3 μm was obtained, and the weave was changed to a ripstop weave. Since the porous first urethane resin layer was coated forcibly to obtain a thickness of 10 μm, coating spots such as strips occurred so that the obtained moisture-permeable waterproof fabric had a poor appearance. The obtained moisture-permeable waterproof fabric was evaluated in a similar manner as Example 1. The results are shown in Table 2.

TABLE 1

| | | | Example 1 | Example 2 | Example 3 | Example 4 | Example 5 |
|---|---|---|---|---|---|---|---|
| Woven fabric | Relative viscosity of raw material | | 3.5 | 3.5 | 3.5 | 3.5 | 2.5 |
| | Total fineness of yarn | warp | 22/20 | 22/20 | 22/20 | 22/20 | 22/20 |
| | (dtex)/filaments | weft | 22/20 | 22/20 | 22/20 | 22/20 | 22/20 |

| | | | | | | |
|---|---|---|---|---|---|---|
| | Setting density (warp direction/weft | 186/207 | 186/220 | 180/212 | 186/207 | 186/207 |
| | direction) (yarns/inch) | | | | | |
| | Finishing density (warp direction/weft | 198/221 | 198/235 | 190/220 | 198/221 | 198/221 |
| | direction) (yarns/inch) | | | | | |
| | Weave | Double ripstop | Ripstop | Plain weave | Ripstop | Ripstop |
| | Cover factor | 1965 | 2030 | 1922 | 1965 | 1965 |
| Moisture- | Porous urethane resin layer | Yes | Yes | Yes | Yes | Yes |
| permeable | Hydrophilic urethane resin layer | Yes | Yes | Yes | Yes | Yes |
| waterproof layer | | | | | | |
| Performance | Thickness of hydrophilic urethane | 20 | 20 | 20 | 5 | 20 |
| evaluation of | resin layer (μm) | | | | | |
| moisture- | Thickness variation of hydrophilic | 27 | 28 | 30 | 75 | 29 |
| permeable | urethane resin layer (%) | | | | | |
| waterproof | Thickness (mm) | 0.08 | 0.08 | 0.08 | 0.06 | 0.08 |
| fabric | Tear strength (warp direction/weft | 10.5/10.0 | 8.5/8.5 | 8.0/8.0 | 11.0/10.0 | 7.0/7.0 |
| | direction) (N) | | | | | |
| | Bending resistance (warp | 25/22 | 25/25 | 23/21 | 10/10 | 28/22 |
| | direction/weft direction) (mm) | | | | | |
| | Moisture permeability (mm/m² · 24 hr) | 5088 | 5020 | 5034 | 7010 | 5000 |
| | Water bearing pressure (kPa) | 53 | 52 | 50.5 | 35 | 50.5 |
| | Permeation of resin to back side | No | No | No | No | No |
| | Texture | 4 | 4 | 5 | 5 | 4 |

TABLE 2

| | | | | |
|---|---|---|---|---|
| Comparative | Comparative | Comparative | Comparative | Comparative |
| Example 1 | Example 2 | Example 3 | Example 4 | Example 5 |

| | | | | | | |
|---|---|---|---|---|---|---|
| Woven fabric | Relative viscosity of raw material | 3.5 | 3.5 | 3.5 | 3.5 | 3.5 |

| | | | | | | |
|---|---|---|---|---|---|---|
| Total fineness of yarn | warp | 22/20 | 22/20 | 22/20 | 22/20 | 22/20 |
| (dtex)/filaments | weft | 22/20 | 22/20 | 22/20 | 22/20 | 22/20 |

| | | | | | | |
|---|---|---|---|---|---|---|
| | Setting density (warp direction/weft | 240/220 | 181/134 | 186/207 | 186/207 | 186/207 |
| | direction) (yarns/inch) | | | | | |
| | Finishing density (warp direction/weft | 250/230 | 196/146 | 198/221 | 198/221 | 198/221 |
| | direction) (yarns/inch) | | | | | |
| | Weave | Ripstop | Ripstop | Ripstop | Ripstop | Ripstop |
| | Cover factor | 2251 | 1613 | 1965 | 1965 | 1965 |
| Moisture- | Porous urethane resin layer | Yes | Yes | Yes | No | Yes |
| permeable | Hydrophilic urethane resin layer | Yes | Yes | No | Yes | Yes |
| waterproof layer | | | | | | |
| Performance | Thickness of hydrophilic urethane | 20 | 19 | 25 | 15 | 3 |
| evaluation of | resin layer (μm) | | | | | |
| moisture- | Thickness variation of hydrophilic | 28 | 39 | 101 | 121 | 85 |
| permeable | urethane resin layer (%) | | | | | |
| waterproof | Thickness (mm) | 0.07 | 0.08 | 0.11 | 0.09 | 0.11 |
| fabric | Tear strength (warp direction/weft | 6.0/5.0 | 15.0/14.0 | 8.0/8.0 | 7.0/6.5 | 8.0/8.0 |
| | direction) (N) | | | | | |
| | Bending resistance (warp | 28/22 | 39/21 | 47/15 | 28/15 | 15/14 |
| | direction/weft direction) (mm) | | | | | |
| | Moisture permeability (mm/m² · 24 hr) | 4600 | 4300 | 4000 | 4500 | 3000 |
| | Water bearing pressure (kPa) | 50.5 | 26 | 105 | 25 | 25 |
| | Permeation of resin to back side | No | Yes | No | No | No |
| | Texture | 2 | 5 | 2 | 2 | 5 |

The moisture-permeable waterproof fabrics produced in Examples 1 to 5 not only had tear strength at a practical level, but also were light, thin, soft in texture and excellent in moisture-permeability and waterproofness.

On the other hand, since the woven fabric having a cover factor more than 2200 was used in Comparative Example 1, the obtained moisture-permeable waterproof fabric had very hard texture, and had low tear strengths of 6.0 N in the warp direction and of 5.0 N in the weft direction. Since the woven fabric having a cover factor less than 1700 was used in Comparative Example 2, the obtained moisture-permeable waterproof fabric was soft and had improved tear strengths of 15.0 N in the warp direction and of 14.0 N in the weft direction. However, in Comparative Example 2, when wet coating was conducted for forming the first urethane resin layer, the resin permeated to the back side of the woven fabric, that is, “permeation of the resin to the back side” occurred. In addition, in Comparative Example 2, the obtained moisture-permeable waterproof fabric had a moisture permeability of 4300 mm/m²·24 hr and a water bearing pressure of 26 kPa, both of which were lower than those of Example 1. Since the porous first urethane resin layer was formed thickly in Comparative Example 3, the obtained moisture-permeable waterproof fabric had a moisture permeability of 4000 mm/m²·24 hr and a water bearing pressure of 105 kPa, both of which reached to a practical level However, in Comparative Example 3, the thickness variation of the hydrophilic second urethane resin layer was 101% and the total thickness was 0.11 mm, thus the obtained moisture-permeable waterproof fabric was felt to be thick and had poor texture. Since the porous first urethane resin layer was not laminated in Comparative Example 4, the thickness variation of the hydrophilic second urethane resin layer was 121%, and the obtained moisture-permeable waterproof fabric had tear strengths of 7.0 N in the warp direction and 6.5 N in the weft direction, a moisture permeability of 4500 mm/m²·24 hr and a water bearing pressure of 25 kPa, all of which were lower than those of Example 1. In addition, in Comparative Example 4, the texture was felt to be hard. Moreover, since the hydrophilic urethane resin layer was coated thinly in Comparative Example 5, the obtained moisture-permeable waterproof fabric was soft but had a low water bearing pressure of 25 kPa.

### INDUSTRIAL APPLICABILITY

The moisture-permeable waterproof fabric of the present invention not only has a tear strength at a practical level but also is light, thin, soft in texture and excellent in moisture permeability and waterproofness. In addition, the moisture-permeable waterproof fabric is felt light and soft during wearing, thus good wearing feel can be obtained. Moreover, the product obtained from the moisture-permeable waterproof fabric of the present invention can be stored compactly, thus the product is very convenient to be carried outside. Therefore, the moisture-permeable waterproof fabric of the present invention is particularly useful for various clothing such as raincoats, outer garments and the like as well as outdoor goods.

### DESCRIPTION OF THE REFERENCE CHARACTERS

1. woven fabric; 3. the first urethane resin layer; 5. the second urethane resin layer

1. A moisture-permeable waterproof fabric in which two urethane resin layers are coated at least on one surface of a woven fabric, wherein
a first urethane resin layer is a porous urethane resin layer which is discontinuously coated on the surface of the woven fabric to fill recesses of a weave crimp but not to cover at least a part of projections of the weave crimp, and
a second urethane resin layer is a hydrophilic urethane resin layer which is continuously coated on the first urethane resin layer and the projections of the weave crimp.

2. The moisture-permeable waterproof fabric according to claim 1, wherein a thickness of the second urethane resin layer is 1 to 30 μm.

3. The moisture-permeable waterproof fabric according to claim 1, wherein a thickness variation of the second urethane resin layer is 80% or less.

4. The moisture-permeable waterproof fabric according to claim 1, wherein
the woven fabric uses a yarn having a total fineness of 8 to 25 dtex which is made from nylon 6 and/or nylon 66 having a relative viscosity of 3.0 or more,
a cover factor (CF) of the woven fabric is 1700 to 2200, and
a weave of the woven fabric is a plain weave, a ripstop or a double ripstop.

5. The moisture-permeable waterproof fabric according to claim 1, wherein
a thickness of the moisture-permeable waterproof fabric is 0.1 mm or less,
a tear strength of the moisture-permeable waterproof fabric in each of warp direction and weft direction, which is measured by JIS L 1096 8. 15. 5 D method, is 8.0 N or more, and
a bending resistance of the moisture-permeable waterproof fabric in each of warp direction and weft direction, which is measured by JIS L 1096 8. 19. 1 A method, is 5 to 35 mm.

6. The moisture-permeable waterproof fabric according to claim 5, wherein the tear strength of the moisture-permeable waterproof fabric in each of warp direction and weft direction is 10.0 N or more.

7. The moisture-permeable waterproof fabric according to claim 1, wherein
a moisture permeability of the moisture-permeable waterproof fabric, which is measured by JIS L 1099 A-1 method, is 4000 mm/m²·24 hr or more, and
a water bearing pressure of the moisture-permeable waterproof fabric, which is measured by JIS L 1092 B method, is 50 kPa or more.

8. A method for manufacturing a moisture-permeable waterproof fabric which is the moisture-permeable waterproof fabric according to claim 1, comprising steps of
(1) coating a first urethane resin liquid for a first urethane resin layer on a surface of a woven fabric to fill recesses of a weave crimp but not to cover at least a part of projections of the weave crimp, and then forming the first urethane resin layer by a wet solidification method; and
(2) continuously coating a second urethane resin liquid for a second urethane resin layer on the first urethane resin layer and the projections of the weave crimp, and then forming the second urethane resin layer by a dry method.
